(19) United States
(12) Patent Application Publication
(10) Pub. No.: US 2026/0250018 A1
(43) Pub. Date: Aug. 27, 2026

(54) Lavatory Arrangement In A Cabin Area Of A Commercial Aircraft

(71) Applicant: Airbus Operations GmbH, Hamburg (DE)

(72) Inventor: Tjark Miles, Hamburg (DE)

(73) Assignee: Airbus Operations GmbH, Hamburg (DE)

(21) Appl. No.: 19/544,307

(22) Filed: Feb. 19, 2026

(30) Foreign Application Priority Data
Feb. 21, 2025 (DE) 102025000647.0

(51) Int. Cl. B64F 5/00; B64D 11/00; B64D 11/06

(52) U.S. Cl. CPC B64F 5/00; B64D 11/00; B64D 11/064; B64D 11/0691; B64D 2011/0046

(57) ABSTRACT

A lavatory arrangement in a cabin area of a commercial aircraft provides a lavatory arrangement suitable for persons with reduced mobility. The lavatory arrangement includes a lavatory with a toilet and a wall arrangement enclosing the lavatory on at least two sides, with at least a first wall and a second wall, wherein the first wall and the second wall are adjacent to each other and are interconnected via a corner area. A first opening with a first movable closure device is provided in the first wall as a toilet door to allow passengers to access the lavatory. A second opening with a second movable closure device is provided in the second wall as a bi-functional wall segment which, in its open state, releases the second opening in the second wall to allow second access to the lavatory by passengers with reduced mobility.

### CROSS REFERENCE TO RELATED APPLICATIONS

The present application claims priority from German Application No. 102025000647.0 filed Feb. 21, 2025, the disclosure of which is hereby incorporated herein by reference.

### FIELD OF THE INVENTION

The present invention relates to a lavatory arrangement in a cabin area of a commercial aircraft, to an aircraft and to a method for the use of a lavatory in a cabin area of a commercial aircraft by passengers with reduced mobility.

### BACKGROUND OF THE INVENTION

Passenger aircraft are provided with on-board toilets that are generally available to passengers during the flight. In order to enable persons with reduced mobility, such as wheelchair users, to use the toilet, WO 2011/101385 A1, for example, discloses a lavatory arrangement in which a movable partition wall is provided to connect two separately usable lavatories to form an extended lavatory. However, it has been shown that there is an increasing need for further improved solutions.

### SUMMARY OF THE INVENTION

An aspect of the present invention relates to a lavatory arrangement that is suitable for persons with limited mobility.

The aspects described below also apply to the lavatory arrangement in a cabin area of a commercial aircraft, to the aircraft and to the method of the use of a lavatory in a cabin area of a commercial aircraft by passengers with reduced mobility.

According to an embodiment of the invention, a lavatory arrangement is provided for a cabin area of a commercial aircraft. The lavatory arrangement comprises a lavatory space with a toilet and a wall arrangement that encloses the lavatory space on at least two sides, with at least a first wall and a second wall. The first wall and the second wall are adjacent to each other and are interconnected via a corner area. A first opening with a first movable closure device is provided in the first wall as a toilet door to allow passengers to access the lavatory. A second opening with a second movable closure device is provided in the second wall as a bi-functional wall segment which, in its open state, releases the opening in the second wall to enable a second access to the lavatory by passengers with reduced mobility.

This results in extended use of the lavatory and thus forms the basis for a lavatory that is suitable for passengers with reduced mobility. The second access may, for example, be larger than the first access point via the toilet door.

According to an example, in the open state, the second movable closure device at least partially encloses a space area outside the lavatory. This space area forms a spatial expansion of the lavatory for use by passengers with reduced mobility.

Together with the actual lavatory, the spatial expansion provides an enlarged room area during use of the toilet, for example by a passenger with reduced mobility who is dependent on a wheelchair. However, the spatial expansion is advantageously not made at the expense of the area available for passenger seats, for example when an entrance and exit area in front of a fuselage door is used for the spatial expansion. The enlarged space meets, for example, the DOT Part 2 PRM requirements of the Department of Transportation.

Providing a pivotable wall section, for example, provides additional space so that a passenger in a wheelchair can be accompanied by an assistant in the lavatory, for example to enable an assisted transfer from the wheelchair to the toilet seat.

The extended use does not affect the other cabin uses.

As an option, the room area outside the lavatory is provided as an entrance and exit area in front of a fuselage door, which is available as a room expansion during travel flight phases.

The entrance and exit area in front of the fuselage door has a dual function, so to speak. This allows for advantageous maximum utilization of the available space.

According to an example, the second movable closure device is movably held at its first lateral edge to a first lateral opening edge of the second wall. The first lateral opening edge is arranged close to the corner area. In the open state, the second movable closure device is temporarily connectable at its second lateral edge to a cabin outer wall area.

This results, for example, in the formation of the largest possible passageway. The connection to the cabin outer wall area encloses the area connected to the lavatory via the passageway, so that an enlarged room area is available for use as a lavatory.

According to an example, the second movable closure device is multi-part and comprises a primary closure element and a secondary closure element. The primary closure element forms the first lateral edge of the second movable closure device at a first edge, with which the closure device is movably held on the second wall. The primary closure element is movably connected to the secondary closure element. The secondary closure element forms the second lateral edge of the second movable closure device at a free end, which is temporarily connectable to the cabin outer wall area.

The two-piece design allows for better adaptation to the resulting room contour.

According to an example, the primary closure element is pivotably held on the second wall with the first edge. The primary closure element is pivotable with a second edge opposite the first edge. The secondary closure element is pivotably held on the primary closure element with a first edge. The secondary closure element is temporarily connectable to the cabin outer wall area with a second edge opposite the first edge, which forms the free end.

An advantage of this is that, due to the arrangement of the two closure elements in the unfolded state, a wall section can be formed that is larger, i.e. longer in its extension, than in the folded state.

According to an example, the second edge of the secondary closure element comprises an edge contour that is adapted to a curvature of the cabin outer wall area.

This ensures that the wall adjoins the outer wall as closely as possible in order to form an improved room closure.

According to an example, the primary closure element comprises a second edge opposite the first edge of the primary closure element. The secondary closure element is provided with a mechanism for pivoting its first edge on the primary closure element at a distance from the second edge of the primary closure element.

This means, for example, that the primary closure element can have an edge contour that differs from the edge contour of the secondary closure element.

According to an example, the primary closure element comprises a first height at the second edge. The primary closure element comprises a second height in an area where the primary closure element is capable of pivoting, which is greater than the edge height.

The primary closure element may, for example, be adapted to the curvature of the outer wall. However, due to the distance, the secondary closure element can still form the best possible vertical closure.

According to an example, the secondary closure element is interchangeable. The secondary closure element can be selected from a plurality of secondary closure elements that comprise various edge contours.

According to the invention, also an aircraft is provided. The aircraft has a fuselage area in which a cabin area is arranged. The cabin area comprises a plurality of passenger seats and sanitary installations. At least one part of the sanitary installations is designed as a lavatory arrangement according to one of the preceding examples.

According to the invention, also a method is provided for the use of a lavatory in a cabin area of a commercial aircraft by passengers with reduced mobility. The method comprises the following steps:

Providing a lavatory arrangement comprising a lavatory and a wall arrangement that encloses the lavatory on at least two sides, with at least a first wall and a second wall, wherein the first wall and the second wall are adjacent to each other and interconnected via a corner area; wherein a first movable closure device is provided in the first wall as a toilet door to allow first access to the lavatory;

Moving a second movable closure device, which is provided as a bi-functional wall segment in the second wall, into an open state so that an opening in the second wall is released to allow second access to the lavatory by passengers with reduced mobility.

According to an aspect of the invention, a lavatory is provided with a second wall opening which, in addition to a second access, also provides an opening for creating an enlarged lavatory suitable for use by a passenger in a wheelchair. In an option, the closure of the opening in the open state is used as a wall element to at least somewhat delimit the further room area.

According to an aspect of the invention, a second door is provided in a lavatory arranged on an outer wall adjacent to the entry and exit area, which opens the lavatory to the side and at the same time separates a room area of the entry and exit area opposite the cabin, thus forming an extended lavatory. Due to the extension and the additional side access provided, the extended lavatory thus created is suitable for use by passengers with reduced mobility. In particular, passengers with their own wheelchairs can use the toilet. The actual toilet door to the aisle area can be narrow, as the passenger in a wheelchair can access the toilet from the side.

It should be noted that the features of the embodiments of the lavatory arrangement also apply to embodiments of the aircraft and the method, and vice versa. In addition, those features that are not explicitly mentioned can also be freely combined with each other.

### BRIEF DESCRIPTION OF THE DRAWINGS

The following describes the embodiments of the invention in more detail with reference to the accompanying drawings.

FIG. 1 schematically shows an example of a lavatory arrangement in a cabin area of a commercial aircraft. The lavatory arrangement is shown in a simplified horizontal section.

FIG. 2 schematically shows an example of an aircraft in a simplified horizontal section.

FIG. 3 shows steps of an example of a method for the use of a lavatory in a cabin area of a commercial aircraft by passengers with reduced mobility.

FIG. 4.1 shows another example of a lavatory arrangement in a schematic floor plan. FIG. 4.1 shows the initial state in which the toilet can be used normally by passengers via the toilet door arranged in the aisle area.

FIG. 4.2 shows the lavatory arrangement from FIG. 4.1 in a second state, in which an area outside the actual lavatory via a second opening as a spatial expansion of the lavatory arrangement enables the use of the toilet by a passenger with reduced mobility.

FIG. 4.3 shows the lavatory arrangement from FIG. 4.2 with a first person in a wheelchair as an example of a passenger with reduced mobility and a second person assisting them.

FIG. 5 shows a perspective view of a movable panel arrangement for opening and closing the second opening.

FIG. 6 shows yet another example of a lavatory arrangement in a schematic floor plan.

### DETAILED DESCRIPTION OF EMBODIMENTS

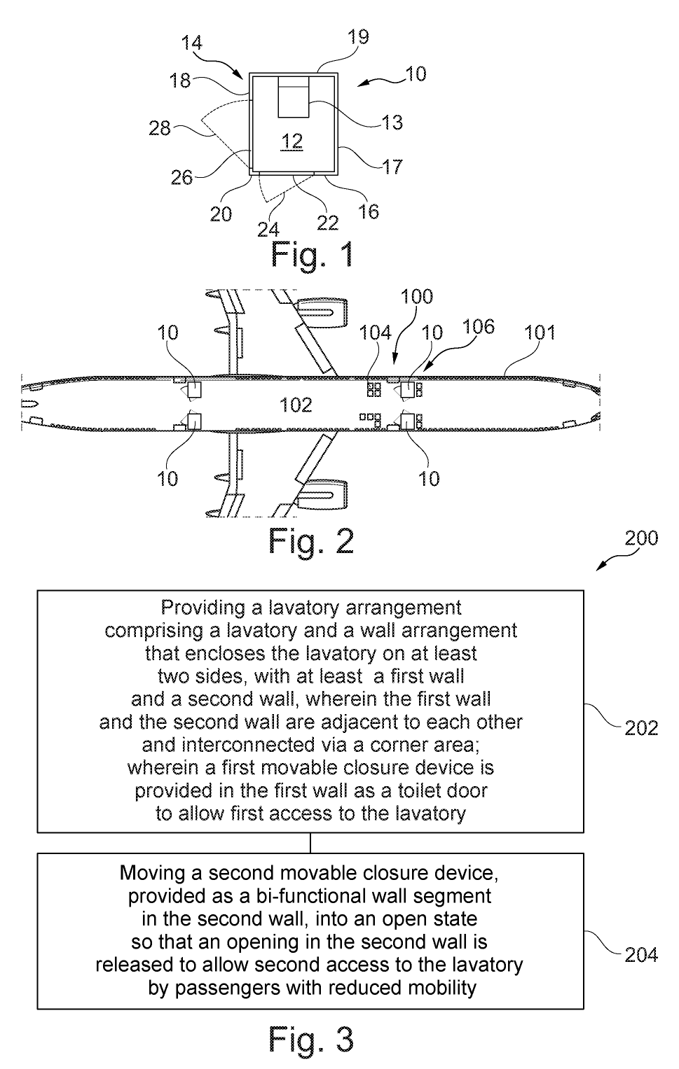

FIG. 1 schematically shows an example of a lavatory arrangement 10 for a cabin area of a commercial aircraft. The lavatory arrangement 10 is shown in a simplified horizontal section. The lavatory arrangement 10 comprises a lavatory room 12 with a toilet 13 and a wall arrangement 14 which encloses the lavatory room 12 on at least two sides. The wall arrangement 14 comprises at least a first wall 16 and a second wall 18, wherein the first wall 16 and the second wall 18 are adjacent to each other and are interconnected via a corner area 20. A first opening 22 with a first movable closure device 24 is provided in the first wall 16 as a toilet door to allow passengers to access the lavatory. A second opening 26 with a second movable closure device 28 is provided in the second wall 18 as a bi-functional wall segment which, in its open state, releases the second opening 26 in the second wall 18 to allow second access to the lavatory by passengers with reduced mobility.

The term "lavatory arrangement" refers to an aircraft toilet on board an aircraft, in particular on board a passenger aircraft. The lavatory arrangement 10 is provided for use by passengers, but may also be used by the aircraft crew, for example flight attendants or pilots. The lavatory arrangement 10 comprises at least one lavatory 12. In an example, several lavatories are combined into a lavatory arrangement in a common structural structure. The lavatory arrangement 10 may also comprise rooms in which a urinal is provided instead of or in addition to a toilet. The lavatory arrangement 10 may also comprise rooms in which only a washbasin is provided. The lavatory arrangement 10 may also be referred to as a lavatory or toilet monument.

The at least one lavatory 12 of the lavatory arrangement 10 may additionally be equipped with a washbasin.

The term "lavatory" refers to the room enclosed by a wall structure.

The term "wall arrangement" refers to the structural elements that enclose the lavatory. The wall arrangement 14 comprises at least the two walls 16, 18. In an example, a third wall 17 is provided, which adjoins the other side of the first wall 16 and is arranged opposite the second wall 18. In the fourth direction, the lavatory 12 is enclosed, for example, by an interior cladding of the outer wall. The third wall is, for example, a partition wall to a seating area or the partition wall to an adjacent further lavatory.

In another example, a fourth wall 19 is provided, which adjoins the second wall 18 and connects it to the third wall 17.

The wall arrangement 14 can also be referred to as a walling arrangement, enclosure arrangement, room enclosure arrangement or room enclosure.

The term "wall" refers to the enclosing surface, for example in the form of a wall panel. The first wall 16 can also be referred to as first wall segment and the second wall 18 as second wall segment.

The term "opening" refers to the passageway in the wall, i.e. the recess in the wall panel that allows a user to enter or exit the lavatory 12.

The term "movable closure device" refers to the movable component that makes the opening lockable. The movable closure device can also be referred to as a door. The first movable closure device 24 can also be referred to as first closure element, primary closure element, first or primary toilet cubicle door, or first or primary door. The second movable closure device 28 may also be referred to as a second movable closure element, a secondary closure element, a second or secondary toilet room door, or a second or secondary door.

The term "bi-functional wall segment" refers to the fact that the second wall 18 fulfils two different functions for two different usage scenarios. In a first scenario, the first function is that of a normal wall when the passenger enters and exits through the toilet door. In a second scenario, the second function is that of a room expansion when an opening is provided that extends the lavatory by a further room area, thus creating an enlarged lavatory, and the enlarged lavatory is available for use by the passenger.

In a first option, access to the enlarged lavatory is via access to the additional room area, for example for a passenger in a wheelchair. As a variant, additional access can also be provided via the toilet door, for example for an assistant to the passenger in a wheelchair.

The second access point to the lavatory allows, for example, access by passengers with reduced mobility (PRM) in a wheelchair.

In a second option, access to the enlarged lavatory is via the toilet door.

The lavatory arrangement 10 is suitable for both new aircraft and for retrofitting existing cabin structures in existing aircraft. After market retrofitting is also known as retrofitting.

The second movable closure device 28 is locked, for example, for normal operation of the toilet, i.e. for operation with an unexpanded space. In normal operation, access is via the first movable closure device 24, i.e. via the toilet door. For operation for a passenger with reduced mobility and a greater space requirement, the second movable closure device 28 can be unlocked and opened. The second movable closure device 28 can be temporarily fixed again in the open position, for example to an outer wall area of the cabin next to the lavatory arrangement 10.

The term "passengers with reduced mobility" refers to passengers who are dependent on assistance, for example through walking aids, walkers or wheelchairs. Special wheelchairs, known as on-board wheelchairs(OBW), which are usually slightly narrower, may be provided on board aircraft for this purpose. However, passengers with reduced mobility may also use their own personal wheelchairs on board.

In an example, the first movable closure device 24 is provided opposite the toilet 13; the second movable closure device 28 is then provided transversely thereto. As an option, the toilet 13 is provided with its main direction of use slightly inclined towards the second movable closure device 28.

In a further example, the lavatory arrangement 10 is provided in a cabin area of a commercial aircraft.

FIG. 2 schematically shows an example of an aircraft 100 in a simplified horizontal section. The aircraft 100 has a fuselage area 101 in which a cabin area 102 is arranged. The cabin area 102 comprises a plurality of passenger seats 104 and sanitary installations 106. At least one part of the sanitary installations 106 is designed as an example of the lavatory arrangement 10 according to one of the preceding examples.

The term "cabin area" refers to the area within the fuselage of the aircraft in which the passengers are accommodated. The cabin area 102 is separated, for example, by a cabin floor from a cargo compartment located below.

The term "sanitary installations" refers to the installations provided in the cabin area 102 in which the sanitary functions, i.e. the toilets, are provided. The sanitary installations 106 are also referred to as lavatories.

FIG. 3 shows steps of an example of a method 200 for the use of a lavatory in a cabin area of a commercial aircraft by passengers with reduced mobility. The method 200 comprises the following steps:

In a first step 202, a lavatory arrangement is provided, comprising a lavatory compartment with a toilet and a wall arrangement which encloses the lavatory compartment on at least two sides, with at least a first wall and a second wall, wherein the first wall and the second wall are adjacent to each other and are interconnected via a corner area; wherein a first movable closure device is provided in the first wall as a toilet door to allow first access to the lavatory; and

In a second step 204, a second movable closure device, which is provided as a bi-functional wall segment in the second wall, is moved into an open state so that an opening in the second wall is released to allow second access to the lavatory by passengers with reduced mobility.

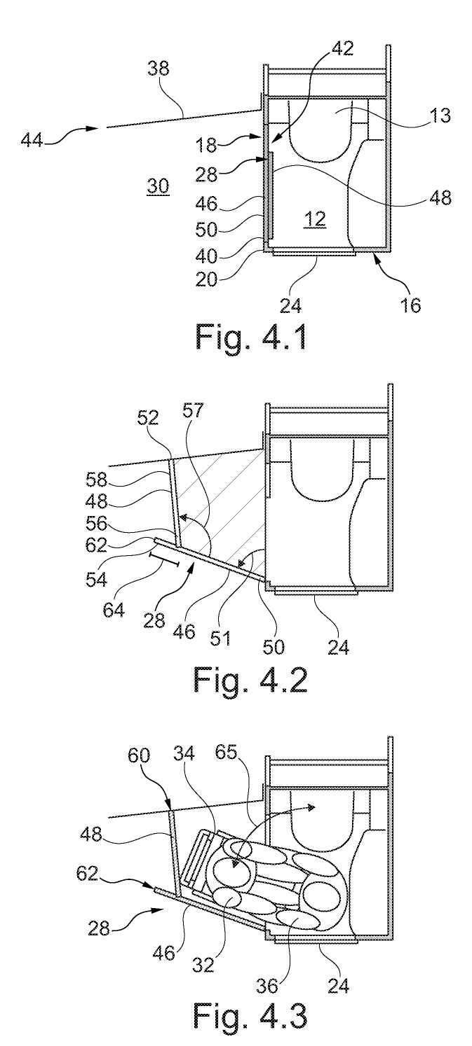

FIG. 4.1 shows another example of the lavatory arrangement 10 in a schematic floor plan. FIG. 4.1 shows the initial state in which the toilet 13 can be used normally by passengers via the toilet door arranged towards a corridor area. FIG. 4.2 shows the lavatory arrangement 10 from FIG. 4.1 in a second state, in which an area 30 outside the actual lavatory 12 via the second opening as a spatial expansion of the lavatory arrangement 10 enables the use of the toilet 13 by a passenger with reduced mobility. FIG. 4.3 shows the lavatory arrangement 10 from FIG. 4.2 with a first person 32 in a wheelchair 34 as an example of a passenger with reduced mobility. A second, assisting person 36 is also shown.

FIG. 4.1 shows an optional design in which the second movable closure device, in the open state (see FIGS. 4.2 and 4.3), at least partially encloses the room area 30 outside the lavatory 12. The room area 30 forms a spatial expansion of the lavatory 12 for use by passengers with reduced mobility. As an option, the room area 30 outside the lavatory 12 is designed to be an entrance and exit area in front of a fuselage door 38, which is available to be used as a room expansion during travel flight phases.

The term "room area" refers to a volume or space defined, for example, by the open second movable closure device 28.

The term "spatial expansion" refers to an additional space that is available for use of the toilet and, together with lavatory compartment 12, forms an enlarged lavatory.

As an option, the second movable closure device 28 is movably held at its first lateral edge 40 on a first lateral opening edge of the second wall, wherein the first lateral opening edge is arranged close to the corner area 20. In the open state, the second movable closure device 28 is temporarily connectable at its second lateral edge 42 to a cabin outer wall area 44.

The term "lateral edge" refers, for example, to the edge or edge area extending vertically in the installed state.

As an option, the second movable closure device 28 may be multi-part and comprises a primary closure element 46 and a secondary closure element 48. The primary closure element 46 forms the first lateral edge 40 of the second movable closure device 28 at a first edge 50, with which the second closure device 28 is movably held on the second wall 18. The primary closure element 46 is movably connected to the secondary closure element 48. The secondary closure element 46 forms the second lateral edge 42 of the second movable closure device 28 at a free end 52, which is temporarily connectable to the cabin outer wall area 44.

The term "multi-part" refers to at least two parts that are movable relative to each other, for example two movably connected panels.

The term "free end" refers to the end that is not held, for example, the end arranged opposite a hinge. The edge of the closure element that is held to a structure by the hinge would then be the "held end".

The primary closure element 46 may also be referred to as first closure element, and the secondary closure element 48 as second closure element. The primary closure element 46 may also be referred to as main panel, and the secondary closure element 48 as additional panel.

The first edge of the primary closure element 46 may also be referred to as first primary edge or first main panel edge, and the second edge of the primary closure element 46 as second primary edge 54 or second main panel edge.

The first edge 56 of the secondary closure element 48 may also be referred to as first secondary edge or first additional panel edge, and the second edge 58 of the secondary closure element 48 as second secondary edge or second additional panel edge.

The secondary closure element 48 is movably held on the primary closure element 46.

In an example, the primary closure element 46 is pivotably held to the second wall 18 with the first edge 50, and the secondary closure element 48 is pivotably held to the primary closure element 46 with a first edge of the secondary closure element 48. The free end of the secondary closure element 48 then forms a second edge of the secondary closure element 48.

As an option (not shown in detail), the secondary closure element 48 is extendably held on the primary closure element 46.

The term "extendable" refers to translational mobility, which can also be combined with rotational movement.

As a further option, the primary closure element 46 is provided with the ability to pivot on the second wall 18, with the first edge 50. The pivoting is indicated by a first rotation arrow 51. The primary closure element 46 is pivotable with a second edge 54 opposite the first edge 50. The secondary closure element 48 is pivotable on the primary closure element 46 with a first edge 56. The pivoting is indicated by a second rotation arrow 57. The secondary closure element 48 is temporarily connectable to the cabin outer wall area 44 with a second edge 58, which is opposite the first edge 56 and forms the free end.

As a further option it is provided that the second edge 58 of the secondary closure element 48 comprises an edge contour 60 that is adapted to a curvature of the cabin outer wall area 44.

The term "edge contour" refers to the profile of the edge in relation to the direction along the edge.

In an example, the second edge 54 of the primary closure element 46 is adapted to the curvature of the cabin wall area.

As a further option, the primary closure element 46 comprises a second edge area 62 opposite the first edge 50 of the primary closure element. The secondary closure element 48 pivots with its first edge 56 on the primary closure element 46 at a distance 64 from the second edge area 62 of the primary closure element 46.

The term "distance" refers to the offset of the pivot axis from the edge, or the second edge area 62, of the primary closure element 46. Instead of attaching the secondary closure element 48 to the outermost end of the primary closure element 46, the secondary closure element 48 is attached to the primary closure element 46 in a slightly indented manner, so to speak.

As an option, the distance 64 may comprise a distance measurement that lies in a range between one-fifth and one-third of the width of the primary closure element 46.

As a further option, the primary closure element 46 comprises an edge height as a first height at the second edge 54. The primary closure element 46 comprises a mounting height as a second height in a region where the primary closure element 46 is capable of Pivoting, which is greater than the edge height.

The term "edge height" refers to the height of the closure element at the free end, i.e. at the outermost edge. The term "mounting height" refers to the height of the closure element at the point where it is mounted, i.e. within the panel or closure element. The mounting height can also be referred to as field height.

FIG. 4.1 shows, as already mentioned, the initial state in which the lavatory 12 is accessible via the toilet door from, for example, a longitudinal corridor area.

FIG. 4.2 shows the extended state, in which the lavatory 12 is opened by swivelling up a part of the side wall, and the opened wall simultaneously partially encloses an area of the entry/exit area adjacent to the lavatory arrangement as a room expansion. This room area is bounded at the rear (the upper side in the figure) by the cabin wall and a fuselage door arranged here.

FIG. 4.3 shows the position of the wall segments or the openable panel segments in the form of the movable closure device from FIG. 4.2. The passenger, i.e. person 32 in the wheelchair, uses the extended space and is assisted by the assistant 36, for example, in transferring from the wheelchair to the toilet or from the toilet to the wheelchair, as indicated by a transfer movement arrow 65.

The transfer is made possible by the temporary extension of the lavatory 12. The transfer is also facilitated by the fact that the wheelchair is not positioned perpendicular to the toilet, but at an angle of less than 90°.

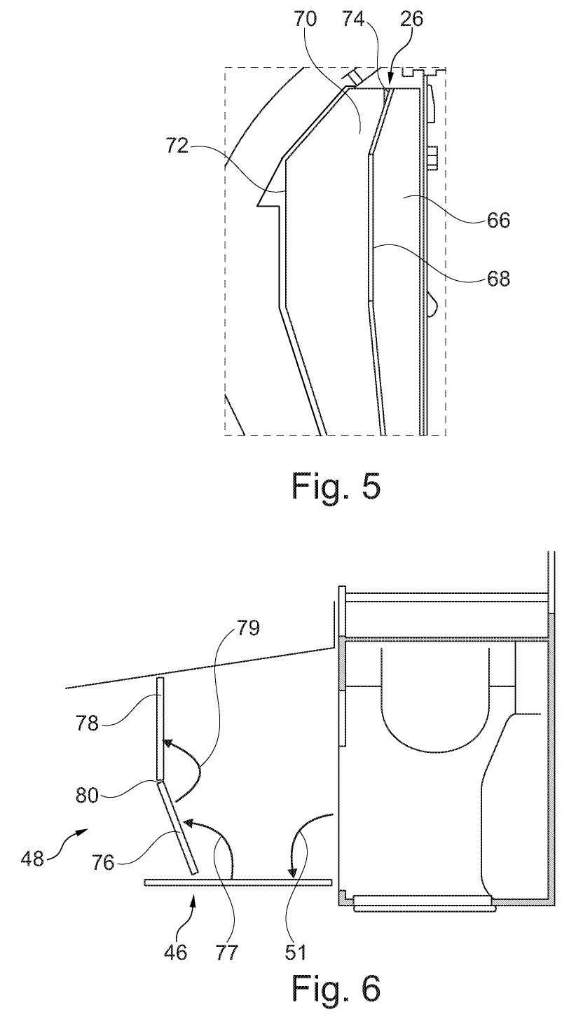

FIG. 5 shows a perspective view of a movable panel arrangement for opening and closing the second opening 26. A first panel 66 forms the second movable closure device 28, or the primary closure element 46 of the second movable closure device 28. The first panel 66 comprises a first edge with a first edge contour 68. A second panel 70 forms the secondary closure element 48 of the second movable closure device 28. The second panel 70 comprises a second edge contour 72. The second panel 70 is movably held on the first panel 66 by a pivot axis 74. The pivot axis 74 is held at a distance from the first edge so that the pivot axis 74 can, for example, extend over the entire height of the second panel. The edge of the first panel 66, i.e. the first edge contour 68, is, for example, adapted to the contour of the cabin wall in order to allow the largest possible opening in the second wall. However, the second panel 68 is not attached to the outer edge, where only a shorter vertical strip would be available, but is offset to a position where the entire height of the panel is available for attachment.

The edge of the second panel 70, i.e. the second edge contour 72, is adapted, for example, to the contour of the cabin wall in order to enable the best possible connection of the second wall to the cabin wall or the fuselage door.

FIG. 6 shows yet another example of the lavatory arrangement 10 in a schematic floor plan.

As an option, the secondary closure element 48 is designed to be a two-piece element, comprising a first part 76 and a second part 78. The first part 76 and the second part 78 are connected via a vertical pivot axis 80.

The pivoting of the first part 76 in relation to the primary closure element 46 is indicated by a third rotation arrow 77. The pivoting of the second part 78 in relation to the first part 76 is indicated by a fourth rotation arrow 79.

As an option (not shown in detail), the secondary closure element 48 is provided to be interchangeable. The secondary closure element 48 can be selected from a plurality of secondary closure elements that comprise various edge contours.

The term "interchangeable" refers to the possibility of replacing the secondary closure element 48. This can be provided with or without tools.

In a variant, the secondary closure element 48 is designed with an interchangeable edge contour, wherein the edge contour can be selected from a plurality of various edge contours. The edge contour can be replaced with or without tools.

The advantage of interchangeability is that the basic design of the lavatory arrangement is more or less universal. Only the components that connect to the cladding of the outer wall are then adapted accordingly.

The embodiments described above can be combined in various ways. In particular, aspects of the devices can also be used for the embodiments of the method and vice versa.

In addition, it should be noted that "comprising" does not exclude other elements or steps, and "one" does not exclude a plurality. It should also be noted that features or steps described with reference to one of the above embodiments may also be used in combination with other features or steps of other embodiments described above. Reference signs in the claims are not to be regarded as limitations.

1. A lavatory arrangement for a cabin area of a commercial aircraft, the lavatory arrangement comprising:
a lavatory with a toilet; and
a wall arrangement enclosing the lavatory on at least two sides, comprising at least a first wall and a second wall, wherein the first wall and the second wall are adjacent to each other and interconnected via a corner area;
wherein a first opening with a first movable closure device as a toilet door is provided in the first wall to allow first access to the lavatory by passengers; and
wherein a second opening with a second movable closure device is provided in the second wall as a bi-functional wall segment which, in an open state, releases the second opening in the second wall to allow second access to the lavatory by passengers with reduced mobility.

2. The lavatory arrangement according to claim 1, wherein the second movable closure device in the open state at least partially encloses a room area outside the lavatory;
wherein the room area forms a spatial expansion of the lavatory for use by passengers with reduced mobility; and
wherein the room area outside the lavatory is an entrance and exit area in front of a fuselage door, which is available to be used as a room expansion during travel flight phases.

3. The lavatory arrangement according to claim 1, wherein the second movable closure device is movably held at a first lateral edge thereof on a first lateral opening edge of the second wall, whereupon the first lateral opening edge is arranged close to the corner area; and
wherein the second movable closure device is temporarily connectable in the open state at a second lateral edge thereof to a cabin outer wall area.

4. The lavatory arrangement according to claim 1, wherein the second movable closure device is multi-part and comprises a primary closure element and a secondary closure element;
wherein the primary closure element forms, at a first edge, the first lateral edge of the second movable closure device, with which the closure device is movably held on the second wall;
wherein the primary closure element is movably connected to the secondary closure element; and
wherein the secondary closure element forms, at a free end, the second lateral edge of the second movable closure device, which is temporarily connectable to the cabin outer wall area.

5. The lavatory arrangement according to claim 4, wherein the secondary closure element is extendably held on the primary closure element.

6. The lavatory arrangement according to claim 4, where the primary closure element is pivotally held on the second wall with the first edge; and the primary closure element is pivotable with a second edge opposite the first edge; and
wherein the secondary closure element is pivotally held on the primary closure element with a first edge; and the secondary closure element is temporarily connectable to the cabin outer wall area with a second edge opposite the first edge and forming the free end.

7. The lavatory arrangement according to claim 6, wherein the second edge of the secondary closure element comprises an edge contour adapted to a curvature of the cabin outer wall area.

8. The lavatory arrangement according to claim 6, wherein the primary closure element comprises a second edge area opposite the first edge of the primary closure element; and
wherein the secondary closure element is pivotably supported with the first edge thereof on the primary closure element at a distance from the second edge of the primary closure element.

9. The lavatory arrangement according to claim 8, wherein the distance comprises a distance measurement that lies in a range between one-fifth and one-third of the width of the primary closure element.

10. The lavatory arrangement according to claim 6, wherein the primary closure element comprises an edge height as a first height at the second edge; and
wherein the primary closure element comprises a mounting height as a second height in a region where the primary closure element is pivoting, wherein the second height is greater than the edge height.

11. The lavatory arrangement according to claim 4, wherein the secondary closure element is two-piece and comprises a first part and a second part; and
wherein the first part and the second part are connected via a vertical pivot axis.

12. The lavatory arrangement according to claim 4, wherein the secondary closure element is interchangeable; and
wherein the secondary closure element is selectable from a plurality of secondary closure elements that comprise various edge contours.

13. An aircraft comprising a fuselage area comprising a cabin area;
the cabin area comprising:
a plurality of passenger seats; and
sanitary installations;
wherein at least a part of the sanitary installations is configured as a lavatory arrangement according to claim 1.

14. A method for enabling passengers with reduced mobility to use a lavatory in a cabin area of a commercial aircraft, wherein the method comprises:
providing a lavatory arrangement comprising a lavatory and a wall arrangement that encloses the lavatory on at least two sides, with at least a first wall and a second wall, wherein the first wall and the second wall are adjacent to each other and interconnected via a corner area; wherein a first movable closure device is provided in the first wall as a toilet door to allow first access to the lavatory; and
moving a second movable closure device, provided as a bi-functional wall segment in the second wall, into an open state so that an opening in the second wall is released to allow second access to the lavatory by passengers with reduced mobility.
